(19) United States
(12) Patent Application Publication
(10) Pub. No.: US 2006/0117133 A1
(43) Pub. Date: Jun. 1, 2006

(54) Processing system

(75) Inventor: Joel Henry Hinrichs, Colorado Springs, CO (US)

Correspondence Address: LAW OFFICE OF DALE B. HALLING, LLC, 655 SOUTHPOINTE COURT, SUITE 100, COLORADO SPRINGS, CO, 80906, US

(73) Assignee: CrowdSystems Corp

(21) Appl. No.: 11/223,855

(22) Filed: Sep. 8, 2005

Related U.S. Application Data
(63) Continuation-in-part of application No. 10/999,677, filed on Nov. 30, 2004.

(51) Int. Cl. G06F 12/00

(52) U.S. Cl. 711/103

(57) ABSTRACT

A processing system on a constructed circuit includes a group of processing cores. A group of dedicated random access memories are severally coupled to one of the group of processing cores or shared among the group. A star bus couples the group of processing cores and random access memories. Additional layer(s) of star bus may couple many such clusters to each other and to an off-chip environment.

### RELATED APPLICATIONS

The present invention claims priority on and hereby incorporates the patent application having Ser. No. 10/999,677, filed on Nov. 30, 2004, entitled “Processing System on an Integrated Circuit” and is a continuation-in-part of said application.

### FIELD OF THE INVENTION

The present invention relates generally to the field of integrated circuits and more particularly to a processing system on an integrated circuit. It also relates to use of emerging techniques which directly, e.g. in a face-to-face manner, bond a plurality of integrated circuits of various, and possibly dissimilar, logic families into a “constructed” circuit of considerable power.

### BACKGROUND OF THE INVENTION

Integrated circuit Central Processing Unit (CPU) architecture has passed a point of diminishing returns. CPUs require greater and greater die surface area for linear increases in clock speed and not necessarily corresponding increases in processed instructions. Present CPUs provide one to three billion instructions per second (1 to 3 GIPS) best case, yet under typical operating conditions these CPUs achieve at most 10% to 20% of their theoretical maximum performance.

Thus there exists a need for a CPU architecture that requires less die surface area and provides a greater theoretical maximum performance and greater performance under typical operating conditions.

### SUMMARY OF THE INVENTION

A processing system on a constructed circuit that solves these and other problems has a number of processing cores coupled together. A number of random access memories are each dedicated to one of the processing cores. A first group of the processing cores are coupled together by a first star bus. A second group of the processing cores may be coupled together by a second star bus and coupled to the first group of processing cores by a third star bus. One or more shared random access memories may be coupled to the first star bus. The first star bus may be a unidirectional bus. One of the cores is disabled when it tests defective. Additional shared random access memory or memories may be coupled to the second star bus.

Alternatively a plurality of the processing cores may be coupled together via a simple message based communications means, either having parallel address, data, and control lines, or having one or a plurality of high speed serial means such as, but not limited to, ethernet, PCI-Express, or similar serial disciplines, forming for instance a two-dimensional interconnected grid.

In one embodiment, a processing system on a constructed circuit includes a group of processing cores. A group of dedicated random access memories are each directly coupled to one of the group of processing cores. A star bus couples the group of processing cores. A shared random access memory may be coupled to the star bus. The shared random access memory may consist of multiple independent parts which are interleaved. A second group of processing cores may be coupled together by a second star bus. The second group of processing cores may be coupled to the first group of processing cores by a third star bus. Each of the group of processing cores may have an isolation system. The star bus may be a unidirectional bus.

In one embodiment, a processing system on a constructed circuit includes a group of processing cores. A group of dedicated random access memories are each directly coupled to one of the group of processing cores. A message based communication means connects each of the processing cores to the others such as to form a grid or message based network. A star bus couples one or a plurality of said random access memories belonging to one of said processing cores to one or a plurality of nearby processing cores. It is anticipated that each of said processing cores will be connected to memories belonging to neighboring cores in a highly symmetrical form of what is known commonly as a “NUMA” or Non Uniform Memory Architecture.+ The shared random access memories may be interleaved. Each of the group of processing cores may be fusable. Some of the shared random access memories may be fusable.

In one embodiment, a processing system on a constructed circuit includes a group of processing cores. A star bus couples the group of processing cores together. A group of dedicated random access memories may each be directly coupled one of the group of processing cores. A number of similar groups of processing cores and random access memories, all joined by star buses, may be coupled to the first group of processing cores by a second level of star bus. A shared group of random access memories may be coupled to the second level star bus. The shared random access memories may be interleaved. Each of the group of processing cores may be fusable. Some of the shared random access memories may be fusable.

### BRIEF DESCRIPTION OF THE DRAWINGS

FIG. 1 is a partial block diagram of a processing system having a multiple cores, each with a dedicated memory, and a plurality of shared memories, on a constructed circuit in accordance with one embodiment of the invention;

FIG. 2 is a partial block diagram of a processing system having a single core, a dedicated memory, and a plurality of sharable memories, on a constructed circuit in accordance with one embodiment of the invention;

FIG. 3 is a block diagram of a processing system having multiple cores, each with a private memory, and with a plurality of shared memories, on a constructed circuit in accordance with one embodiment of the invention;

FIG. 4 is a block diagram of a processing system having multiple groups of multiple cores on a constructed circuit in accordance with one embodiment of the invention;

FIG. 5 is a block diagram of a processing system for a switch having a group of cores on a constructed circuit in accordance with one embodiment of the invention; and

FIG. 6 is a block diagram of a processing system for a switch having multiple groups of multiple cores with a central data memory on a constructed circuit in accordance with one embodiment of the invention;

FIG. 7 is a partial block diagram of a processing system having a multiple cores, each with a dedicated memory, and a plurality of shared memories, on a constructed circuit in accordance with one embodiment of the invention.

### DETAILED DESCRIPTION OF THE DRAWINGS

The present invention overcomes the limitations present CPU (central processing unit) architectures by having a number or simple processing cores coupled together with small dedicated RAMs (Random Access Memory). This increases the efficiency in the use of die space, since a number of simple cores require significantly less die space for the same theoretical computation power. The use of dedicated local RAM also increases the real computation power of the cluster of processing cores, since the memory access speed is significantly increased. First the memory speed is increased by virtue of the large number of independent RAMs present; and second the memory speed is increased by virtue of the much wider word size available on a die because there is no pin limitation; and third the memory speed is increased by virtue of the fact that very small RAMs have smaller physical distances to traverse hence are inherently faster; and fourth the memory speed is increased by virtue of the fact that there are no chip-to-chip line drivers and no lengthy chip-to-chip signal paths to traverse.

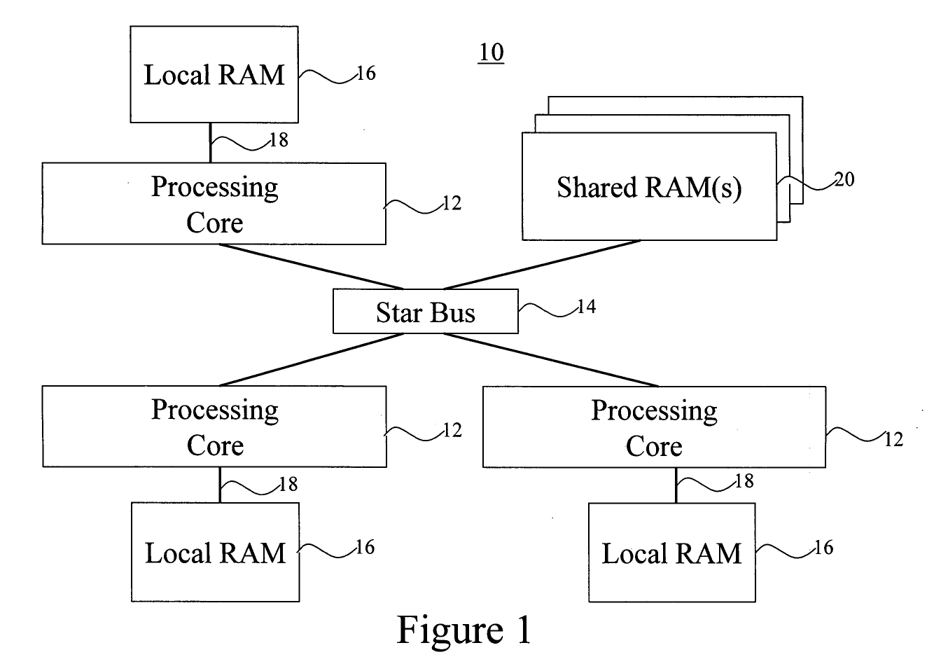

FIG. 1 is a block diagram of a processing system 10 on a constructed circuit in accordance with one embodiment of the invention. The processing system 10 has a number of processing cores 12. Commonly, each of the processing cores 12 is exactly the same. The processing cores 12 are coupled together usually by a star bus 14. For each processing core 12 there is a dedicated RAM 16 coupled to the processing core 12 by a dedicated bus 18. In another embodiment, many but not all processing cores 12 have dedicated RAMs 16. The processing cores 12 also have access to one or more shared RAMs 20 through the star bus 14.

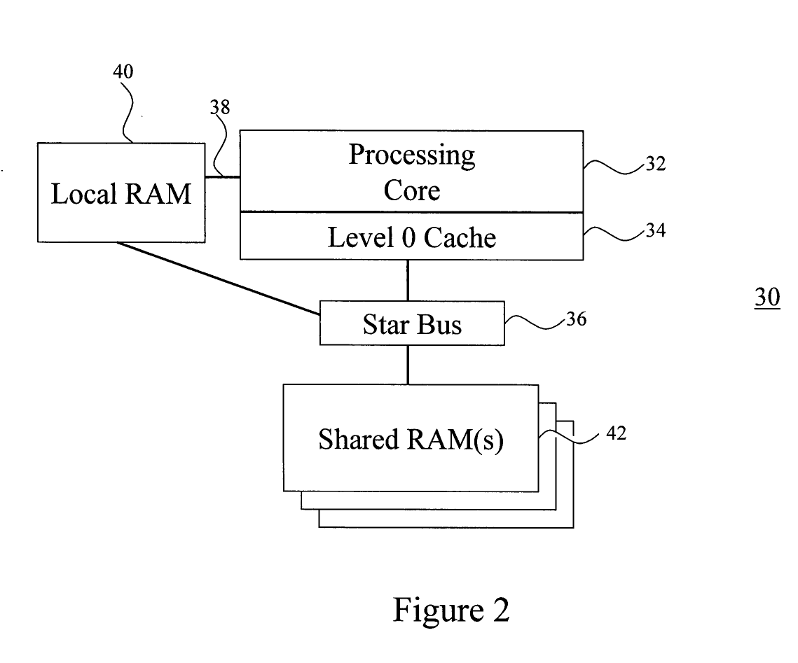

FIG. 2 is a partial block diagram of a processing system 30 on a constructed circuit in accordance with one embodiment of the invention. The processing system has a processing core 32. The processing core 32 has a level zero cache 34 and is coupled to a common access port. One embodiment of the common access port is shown, Star Bus 36. The processing core 32 is also coupled through a dedicated bus 38 to a local RAM (Random Access Memory) 40. The common access port 36 is coupled to the local RAM 40 and to one or more shared RAMs 42.

Note that the processing core 32 (cores 12, FIG. 1) may be simple cores that are generally limited only to those elements which have an immediate practical value. The processing core's 32 instruction set may be generally mapped onto the specific set of machine instructions utilized by C or C++ compilers. This is because computer code that is not written in direct machine language is usually written in C or C++ language. Higher level application languages tend to be embodied in computer code written in C or C++. As a result, this allows the cores 32 (12) to handle most computer programs. The cores may generally not be pipelined and not have specialty instructions for enhancing graphics, text editing or other user-interface matters. In one embodiment, the processing cores are thirty-two bit, single address, CISC cores. These cores may only require 50,000 to 75,000 logic gates.

The level zero cache is generally very small. It may be as little as one-quarter to one-half kilobytes of live code and data storage.

The use of local on chip RAM provides access to data required by the processing cores in far less than the sixty to one hundred nanosecond times for external RAM. This significant reduction in access time is due to the short signal paths that the data travels and due to the fact that the local RAM is very small compared to most external RAMs and finally due to the fact that there is a smaller probability of contention for the signal paths the data travels over. Note that small at the time of this application means that a RAM may be between 128 KBytes and 512 KBytes.

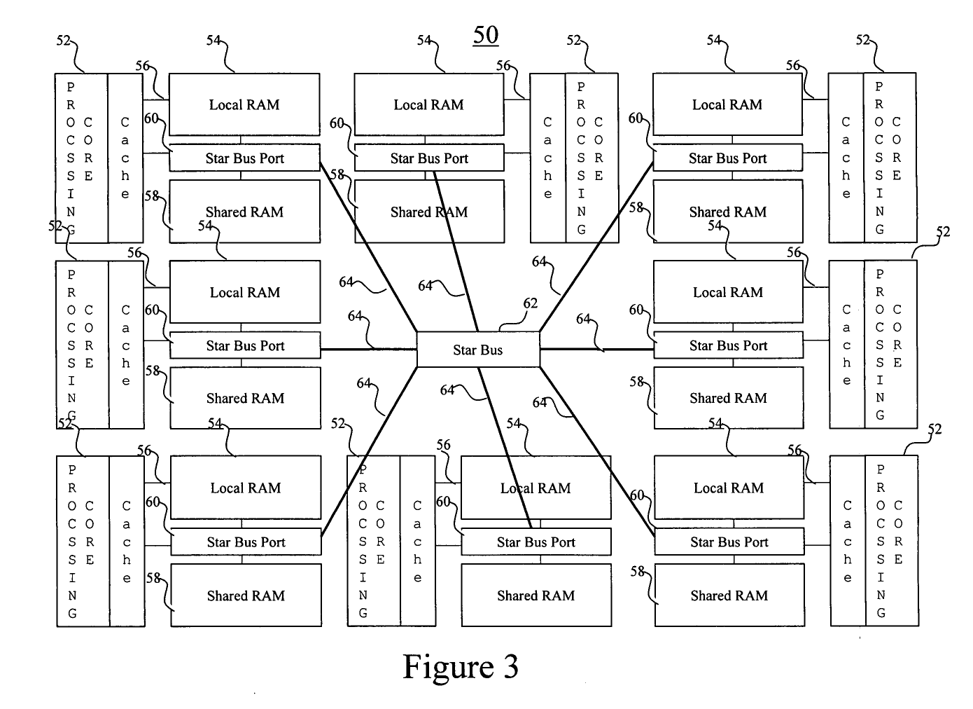

FIG. 3 is a block diagram of a processing system 50 on a constructed circuit in accordance with one embodiment of the invention. This figure shows how a number of processing cores 52 may be coupled together in one embodiment. Each of the processing cores 52 is coupled to a dedicated RAM 54 by a dedicated bus 56. Associated with each processing core 52 is shared RAM 58 that is accessed through a common access port 60. Each of the common access ports 60 are coupled to a group common access port 62. The group common access port 62 forms a star bus that allows each of the processing cores 52 to directly communicate with each other or the shared RAMs 58. A common access port is a small bus controller that receives a request for access and then provides a path between the sender and receiver. Normally, the bus will not use tri-stating. This saves gates and die space. Tri-stating is not necessary because of the ability to form multiple discrete, unidirectional signal paths. In one embodiment, the common access port or star bus is set up to be a bus that operates in a unidirectional manner. This means that common access port only allows the bus to be tied up for one bus event. It does not literally mean that the bus only transports data in one direction. In fact since signal paths are not tri-stated and are unidirectional, this bus will tend to consist of, and operate, as two parallel one-way buses with overlapping operation. As a result, a write operation passes data in a single bus event while a read operation passes the request in one bus event, and later the data returns in a second bus event and traveling in the reverse direction; a read therefore requires one event on each of two buses. A request for data from one of the processing cores 52 to one of the shared RAMs 58 may first query that the bus 56 is available and receive an acknowledgement. The processing core would then send the read request. The bus then would be made available for other traffic. The RAM may respond during that bus event with a “not ready” signal, in which case the core 52 repeats the process of acquiring the bus and signaling RAM 58. When the RAM was ready to transmit the requested data, it also would first request access to the portion of the bus operating in the reverse direction, then use that portion of the bus to return data to the core 52. This “unilateral” function of the bus allows efficient use of the bus, so that it is not tied up just waiting for a response to an instruction.

In one embodiment, the shared RAMs 58 have interleaved addresses. Interleaving is a method whereby some less-significant address bits select one of the RAMs 58, and the remaining bits address data within the RAM 58. Each different combinations of those less-significant address bits selects a different one of the RAMs 58. The result is that a sequence of neighboring words will tend to come from each RAM 54, 58 in sequence. This enhances the likelihood that the processing cores 52 will fall into a pattern of using the RAMs 58 sequentially. In addition, this will allow the processing cores 52 to keep many of the RAMs 54, 58 busy simultaneously.

In one embodiment, the bus 56 and the other buses have wide signal paths and the RAMs have large word widths. For instance, the RAMs may have a word width of 32 bytes. This allows a full 32 byte word to be written beginning at any byte boundary. In addition, any byte, word, double word etc. in the 32 byte word may be written without disturbing the contents of any other parts of the 32 byte RAM word. It also allows any single bit or field of bits to be accessed.

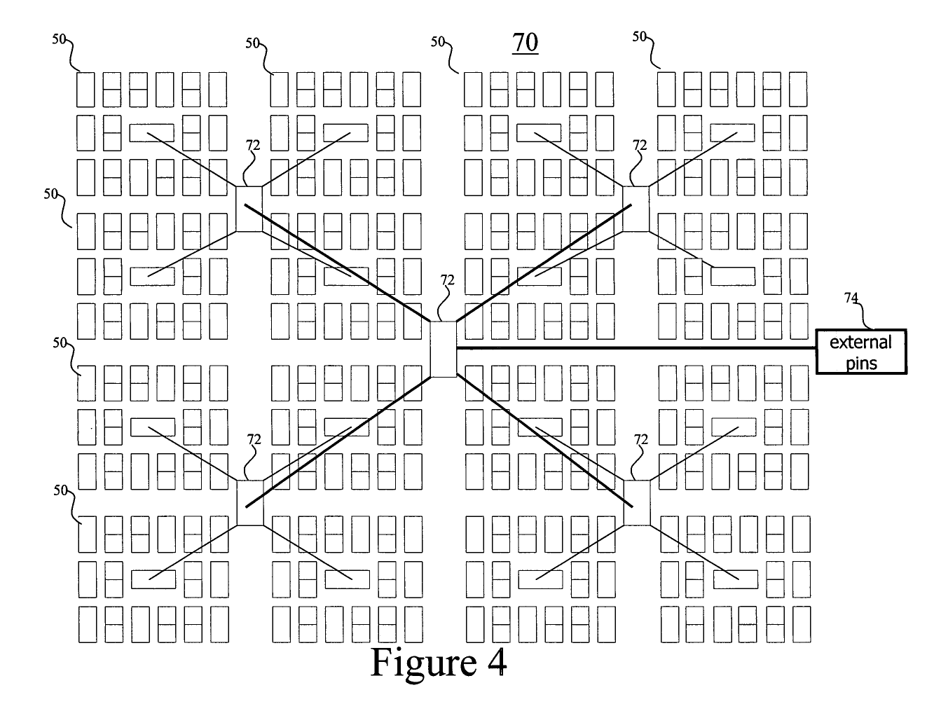

FIG. 4 is a block diagram of a processing system 70 on a constructed circuit in accordance with one embodiment of the invention. This figure illustrates how the structure of figure three is repeatable to increase the number of processing cores. The processing cores 62 are grouped into clusters of, for example, eight processing cores. Sixteen clusters 50 are shown coupled together by common access ports 72. Each of these clusters or groups has the same architecture as that shown in figure three. The common access ports 72 create a hierarchical or tree structure to the star buses. The central common access port 72 is the highest node in the star bus tree and is coupled to external pins 74 that allow signals to be passed on or off the integrated circuit.

The invention may be used with cores made to execute either a CISC (Complex Instruction Set Computers) instruction set or a RISC (Reduced Instruction Set Computers) instruction set. Generally, a CISC architecture uses about one half the total bytes per unit function compared to a RISC architecture. As a result, a CISC architecture imposes about one half the burden on the memory interface that delivers the code, hence and will be likely to run faster whenever the delivery of code to the core is the limiting factor. That said, cores with a RISC design will also function well as embodiments of the invention.

In one embodiment, any of the processing cores 52 or RAMs may be isolated if during testing a defect is found. A processing core may be isolated by a fusable link or under firmware control or other means. This increases the yield of integrated chips using this architecture over monolithic CPUs, since the system 70 is still usable and powerful without all the processing cores 52 being active. As a result, the architecture shown herein is a more cost effective approach to increase the computational power of a processor on a chip.

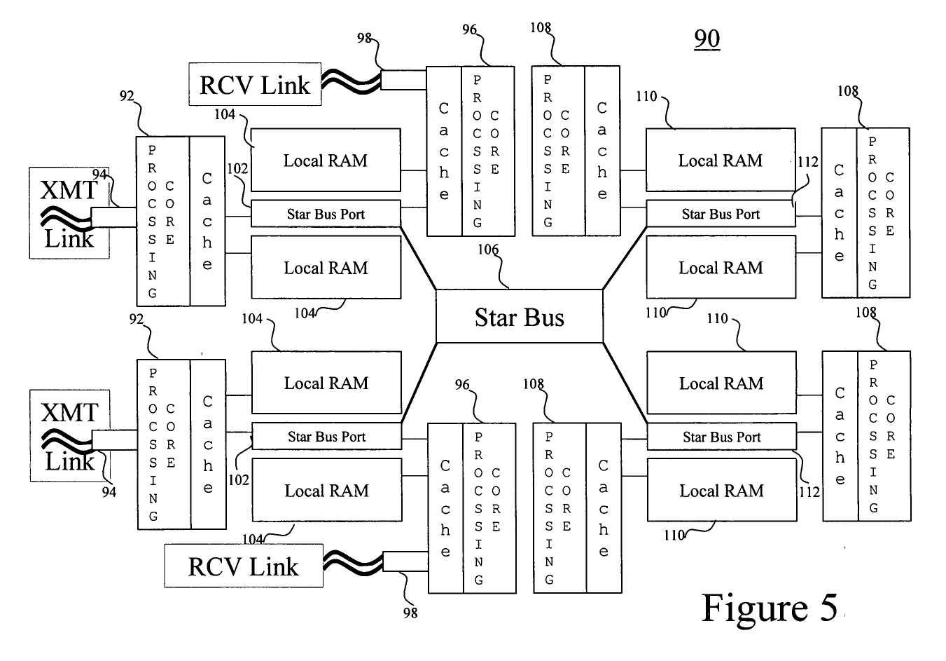

FIG. 5 is a block diagram of a processing system for a switch 90 on a constructed circuit in accordance with one embodiment of the invention. The figure is similar to the system shown in figure three. The system 90 has a first group of processing cores 92 coupled to transmit links 94. A second group of processing cores 96 are coupled to receive links 98. The first group of processing cores 92 are each coupled to a local RAM 100 and a common access port 102. The second group of processing cores 96 are each coupled to a local RAM 104 and a common access port 102. The common access ports 102 are coupled to a central common access port 106. A third group of processing cores 108 are dedicated to overhead tasks associated with the transmit link 94 and receive link 98. The third group of processing cores 108 are coupled to local RAMs 110 and to common access ports 112. The first group 92 and second group 96 of processing cores are responsible for the primary task of the switch 90. The third group of processing cores 108 are used for overhead tasks such as changes in data format, error correction calculations, etc.

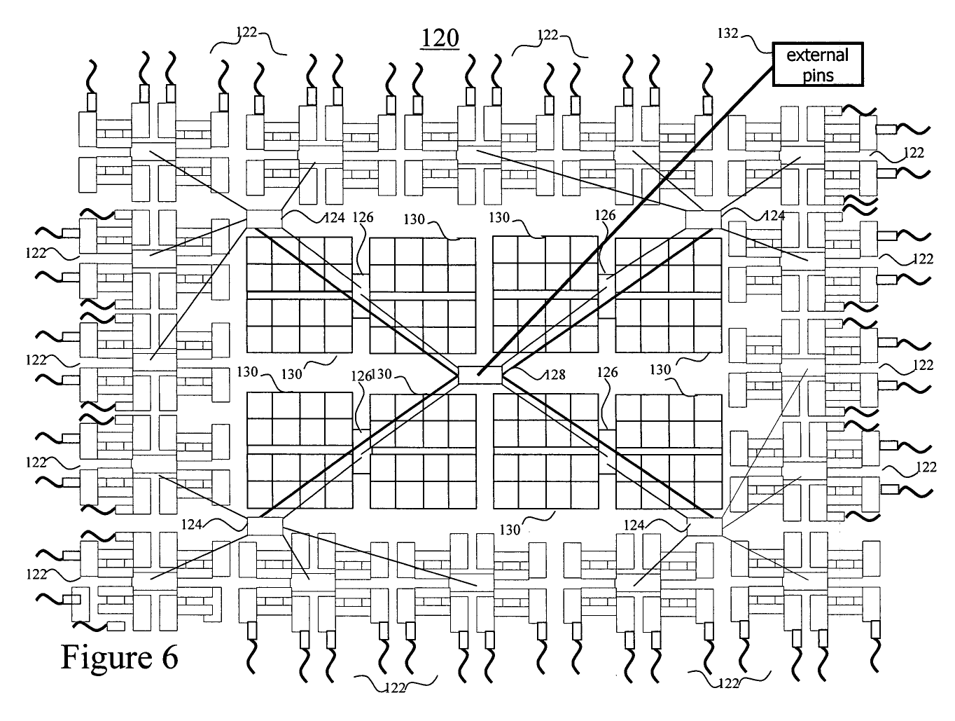

FIG. 6 is a block diagram of a processing system for a switch 120 on a constructed circuit in accordance with one embodiment of the invention. The system 120 illustrates the embodiment of sixteen clusters 122 that are like the system 90 of FIG. 5. Each of the clusters 122 are coupled to a second tier common access port 124. Each of the second tier common access ports 124 are coupled to RAM common access ports 126 and a third tier common access port 128. Each RAM common access port is coupled to two RAM memory blocks 130 and to the third tier common access port 128. The third tier common access port 128 is coupled to external pins 132 that are used to access and send data off the integrated circuit. The total number of three tiers is not claimed as a required part, but only to illustrate the use of a layering of buses to achieve an optimum means to transport data across the chip between the various clusters and to transport data between any cluster and an off-chip connection.

Thus there has been described a processing system that has significantly more processing power for the same amount of die area than present CPUs. Depending on the application, the processing system of the present invention can process perhaps tens of times the number of instructions using the same die area as present CPUs.

While the invention has been described in conjunction with specific embodiments thereof, it is evident that many alterations, modifications, and variations will be apparent to those skilled in the art in light of the foregoing description. Accordingly, it is intended to embrace all such alterations, modifications, and variations in the appended claims.

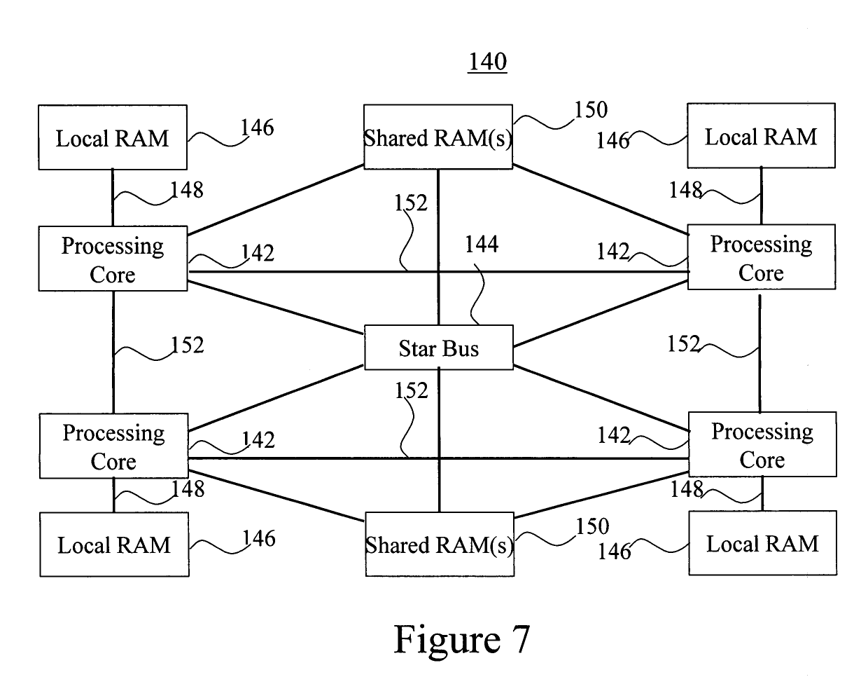

FIG. 7 is a block diagram of a processing system 140 on a constructed circuit in accordance with one embodiment of the invention. The processing system 140 has a number of processing cores 142. Commonly, each of the processing cores 142 is exactly the same. The processing cores 142 are coupled to shared RAMs usually by a star bus 144. For each processing core 142 there is a dedicated RAM 146 coupled to the processing core 142 by a dedicated bus 148. In another embodiment, many but not all processing cores 142 have dedicated RAMs 146. The processing cores 142 also have access to one or more shared RAMs 150 through the star bus 144. The processing cores 142 are each coupled to the other by message based communications means 152; in a preferred embodiment the processing cores 142 are connected in a symmetrical two-dimensional grid by communications means 152.

What is claimed is:

1. A processing system on a constructed circuit, comprising:
a plurality of processing cores coupled to together; and
a plurality random access memories, each of the plurality of random access memories dedicated to one of the plurality of processing cores.

2. The system of claim 1, wherein a first group of the plurality of processing cores are coupled together by a first star bus.

3. The system of claim 2, wherein a second group of the plurality of processing cores are coupled together by a second star bus and coupled to the first group of the plurality of processing cores by a third star bus.

4. The system of claim 2, further including a shared random access memory coupled to the first star bus.

5. The system of claim 2, wherein the first star bus is a unidirectional bus.

6. The system of claim 1, wherein one of the plurality of processing cores is disabled when it tests defective.

7. The system of claim 3, further including a shared random access memory coupled to the second star bus.

8. A processing system on a constructed circuit, comprising:
a group of processing cores;
a group of dedicated random access memories, each of the dedicated random access memories directly coupled one of the group of processing cores; and
a star bus coupling the group of processing cores.

9. The system of claim 8, further including a shared random access memory coupled to the star bus.

10. The system of claim 9, wherein the shared random access memory is interleaved.

11. The system of claim 8, further including a second group of processing cores coupled to the group of processing cores by a second star bus.

12. The system of claim 11, wherein the second group of processing cores are coupled together by a third star bus.

13. The system of claim 8, wherein each of the group of processing cores an isolation system.

14. The system of claim 8, wherein the star bus is a unidirectional bus.

15. A processing system on a constructed circuit, comprising:
a group of processing cores; and
a star bus coupling the group of processing cores.

16. The system of claim 15, further including a group of dedicated random access memories, each of the dedicated random access memories directly coupled one of the group of processing cores.

17. The system of claim 15, further including a plurality of groups of processing cores coupled to the first group of processing cores by a second star bus.

18. The system of claim 16, further including a shared random access memory coupled to the star bus.

19. The system of claim 18, wherein the shared random access memory is interleaved.

20. The system of claim 19, wherein each of the group of processing cores is fusable.
